(19) United States
(12) Patent Application Publication
(10) Pub. No.: US 2017/0195561 A1
(43) Pub. Date: Jul. 6, 2017

(54) AUTOMATED PROCESSING OF PANORAMIC VIDEO CONTENT USING MACHINE LEARNING TECHNIQUES

(71) Applicant: 360fly, Inc., Canonsburg, PA (US)

(72) Inventors: Simon Hegelich, Siegen (DE); Michael Rondinelli, Canonsburg, PA (US); Geoffrey T. Anderson, Pittsburgh, PA (US); Kolja Hegelich, Dorsten (DE); Morteza Shahrezaye, Bonn (DE); Claudio Santiago Ribeiro, Evanston, IL (US); Sybren Daniel Smith, Plantation, FL (US); Moisés De La Cruz, Cooper City, FL (US); John Nicholas Shemelynce, Fort Lauderdale, FL (US); Pratik Desai, Boca Raton, FL (US); Felippe Morais Bicudo, Fort Lauderdale, FL (US)

(21) Appl. No.: 14/988,209

(22) Filed: Jan. 5, 2016

(51) Int. Cl. H04N 5/232; G06K 9/66; G06K 9/62; H04N 5/77; H04N 5/225

(52) U.S. Cl. CPC H04N 5/23238; H04N 5/77; H04N 5/2253; G06K 9/6278; G06K 9/66

(57) ABSTRACT

The present disclosure provides techniques for capturing, processing, and displaying panoramic content such as video content and image data with a panoramic camera system. In one embodiment, a method for processing panoramic video content may include communicating captured video content to a virtual sensor of a panoramic camera; applying a machine learning algorithm to the captured video content; identifying content of interest information suitable for use by at least one smart application; and executing a smart application in connection with the identified content of interest information. The machine learning algorithm may include at least one of a pattern recognition algorithm or an object classification algorithm. Examples of smart applications include executing modules for automatically panning movement of the camera field of view, creating video content focused on the content of interest, and warning a user of objects, obstacles, vehicles, or other potential hazards in the vicinity of the panoramic camera.

### FIELD OF THE INVENTION

The present invention generally relates to panoramic camera systems and processing content derived from panoramic camera systems. In certain embodiments, the invention relates to capturing, processing, and displaying panoramic content such as video content and image data derived from a panoramic camera.

### BACKGROUND INFORMATION

During presentation of 360° panoramic video content, the user typically sees only a small sector of the whole video at any given moment. Accordingly, the user might miss interesting scenes or objects of interest, or might need to watch the video several times from different angles or points of view to see all content of interest. Recorded panoramic action videos sometimes contain long and uneventful segments. Even if traditional motion detection techniques are employed to find content of interest in panoramic video content, switching from one perspective containing content of interest to another perspective often leads to a poor user experience because the video often jumps or skips unnaturally when viewed. When the user views live panoramic video content, the user is constrained by the field of view of human vision, potentially missing hazards from angles outside of the field of view, such as moving vehicles, flying objects, or other obstacles.

Conventional motion detection techniques do not work the same way on 360° panoramic videos as with narrow field of view captured video content. Also, the panoramic camera system is often itself an action camera that may be moving during use, and this adds complexity to the problem of viewing the content. In one example, the curve of the lens of a panoramic camera can introduce a near-far problem where objects viewed from one area of the lens appear closer than when viewed from other areas of the lens. In addition, not every movement or object is equally interesting, and there are often multiple movements, especially when analyzing the whole 360° panoramic view. Accordingly, using intelligent decisions to select the most interesting segments or content of interest would significantly improve the viewing experience, especially for human users.

What are needed are enhanced techniques, tools, and solutions which can employ machine learning algorithms to recognize patterns and classify objects in panoramic video content to identify content of interest.

### SUMMARY OF THE INVENTION

An aspect of the present invention is to provide a method for processing panoramic video content. In one embodiment, a method for processing panoramic video content includes communicating captured video content to a virtual sensor of a panoramic camera; applying a machine learning algorithm to the captured video content; identifying content of interest information suitable for use by at least one smart application; and executing a smart application in connection with the identified content of interest information. In certain embodiments, the machine learning algorithm may include at least one of a pattern recognition algorithm and/or an object classification algorithm. For example, various smart applications can be executed by modules programmed for automatically panning movement of the camera field of view, creating video content focused on the content of interest, and warning users about objects, obstacles, vehicles, or other potential hazards in the vicinity of the panoramic cameras.

A further aspect of the invention is to provide system and computer-readable media embodiments which process panoramic video content in accordance with various embodiments of the invention described herein.

These and other aspects of the present invention will be more apparent from the following description.

### BRIEF DESCRIPTION OF THE DRAWINGS

FIG. A includes a schematic representation of one example of a panoramic camera system which can be provided in accordance with certain embodiments of the invention;

FIGS. 1 and 2 include process flow diagrams illustrating examples of processes and software components which can be provided in accordance with certain embodiments of an automation module;

FIGS. 3-6 include process flow diagrams illustrating examples of processes and software components which can be provided in accordance with certain embodiments of an autopilot module;

FIGS. 7-10 include process flow diagrams illustrating examples of processes and software components which can be provided in accordance with certain embodiments of an autocut module;

FIGS. 11-14 include process flow diagrams illustrating examples of processes and software components which can be provided in accordance with certain embodiments of an autowarning module;

FIG. 15 includes a screen capture of a sample of captured video content;

FIG. 16 includes a screen capture illustrating the result of applying a machine learning pattern recognition technique to the captured video content of FIG. 15;

FIG. 17 includes a screen capture of the captured video content of FIG. 15 highlighting content of interest within the captured video content;

FIG. 18 includes a screen capture illustrating another result of applying a machine learning pattern recognition technique to the captured video content of FIG. 15;

FIG. 19 includes a screen capture of the captured video content of FIG. 15 highlighting content of interest within the captured video content;

FIG. 20 includes a screen capture of a sample of captured video content;

FIG. 21 includes a screen capture illustrating the result of applying a machine learning pattern recognition technique to the captured video content of FIG. 20; and,

FIG. 22 includes an exploded view of an example of a panoramic camera which can be employed in connection with various embodiments of the invention described herein.

### DETAILED DESCRIPTION

In various embodiments, the invention provides panoramic cameras, camera systems, and other devices programmed for capturing, processing, and displaying content derived from generating panoramic video content. In certain embodiments, panoramic video content may be processed to include areas or objects of interest identified within the content. Machine learning techniques using pattern recognition or object classification, for example, can be applied to the panoramic video content to assist with identification and processing of content of interest.

In developing embodiments of the present invention, the inventors have recognized that each pixel in a video frame can be described as a data point with multiple variables such as coordinates and color values, for example. By comparing data from consecutive video frames, machine learning algorithms such as cascade classification, random forest classification, boosting, clustering, or other pattern recognition or object classification algorithms can be used to identify patterns or objects of interest in the video content. Because computer vision techniques are based on the data derived from the pixels of the video content, there is often a “semantic gap” between recognized patterns and their true meaning. For example, objects may not be recognized as objects but as diffuse areas of pixels, or changes in light might appear as movement. This semantic gap is heightened in the panoramic video context because of the need to translate and present three-dimensional panoramic video content in a two-dimensional representation (e.g., on the screen of a mobile phone, computer, or other device). Therefore, methods and algorithms normally applicable to non-panoramic video content cannot be applied directly to panoramic video content without creating issues with accurate presentation and display of the video content.

In one example shown schematically in Figure A, a panoramic camera system 2 may include a camera 4 combined with one or more additional devices 6 to store data, to run computations, to view videos, to provide user interfaces, to communicate data through communication media 8 or networks, to communicate with various computer systems 10, and/or to organize the communication between or among different components of the system, among other tasks or functions. For example, the panoramic camera 4 may be operatively associated with various modules 4A-4E programmed to execute computer-implemented instructions for processing and analyzing panoramic content. The tasks and functions described herein can be combined in single devices like smart phones, mobile devices, computing devices, or other access devices 6, for example, or they can be integrated with more complex systems such as web servers 10. The architecture of the panoramic camera system 2 can be modified to meet different requirements. For example, it might be useful to concentrate all modules 4A-4E directly on the camera device 4 to reduce the amount of data that has to be transferred after video content has been captured. For other applications, it may be more desirable to integrate one or more of the modules on servers 10 to which the video content can be uploaded and processed. It can be appreciated that different panoramic camera systems may employ one or a combination of a panoramic camera, an access device, a computer system, or other suitable components.

In various embodiments, an automation module 4A can be provided which represents a general approach for developing and implementing smart applications in a panoramic camera system which can be executed by the various modules 4B-4D described below. In certain embodiments, one or more machine learning algorithms using pattern recognition or object classification techniques, for example, can be applied to panoramic video content by the automation module 4A. One or more algorithms executed by the automation module 4A can operate to analyze the video and automatically display the most interesting sector in each frame, for example.

In certain embodiments, an autopilot module 4B can be programmed to detect movement patterns in panoramic video content. For example, the autopilot module 4B may calculate the difference between two frames, create a background model to substrate the movement of the camera, shrink the moving areas and blur them to combine connected pixels, measure the volume of the remaining moving areas, filter the results according to the curvedness of the lens, and then report for each frame the coordinates of the largest remaining pixel area. Then remaining gaps (e.g., frames without any pattern motion detection) can be filled, and the resulting data for each video can be transferred to data storage or to a display for viewing by a user. The autopilot module 4B may take the coordinates of interesting events or content of interest in the video and navigate from one sector to the next set of coordinates of interest that can be reached in a defined time without a visually undesirable amount of skipping or jumping thereby promoting a smoother viewing experience.

The same techniques for pattern recognition and machine learning techniques used to execute the autopilot module 4B video may also be used by an autocut module 4C to create video content. In various embodiments, the autocut module 4C can be programmed to automatically edit video created by the autopilot module 4B into a sub-set of the entire video comprising one or more interesting sectors. This results in video content representing a shorter segment (e.g., made shorter in terms of time length) of the entire originally captured panoramic video content. The autocut module 4C may be programmed for automatic editing of recorded panoramic video into a shorter video clip with a narrow field of view based on machine learning using techniques for pattern matching and object classification, for example.

In various embodiments, an autowarning module 4D can be programmed to generate and communicate notifications and directed video points of view showing a potential hazardous situation such as an impending collision with a vehicle, aircraft, moving object, or other obstacle. Various components of the system 2 can be programmed to highlight these potential warnings during live viewing, such as through audible, visual, or other types of warning signals communicated to the user. For example, a machine learning pattern recognition algorithm may be used during live viewing, for example, to provide collision or other hazard warning (e.g., flying aircraft or moving land vehicles). Options for collision detection and warning functions performed by the autowarning module 4D may include (a) presentation of a narrow field of view of the impending collision on a local or remote display device; (b) automatic alerts for user or remote viewer that provide collision avoidance advice; and/or (c) automatic capture of entire panoramic video before, during, and after collision. In certain embodiments, the collision potential or risk level may be determined based on machine learning techniques using motion pattern analysis, for example. The presentation of an urgent situation to the user could be performed through automatically generating warning signals which can be communicated to the user.

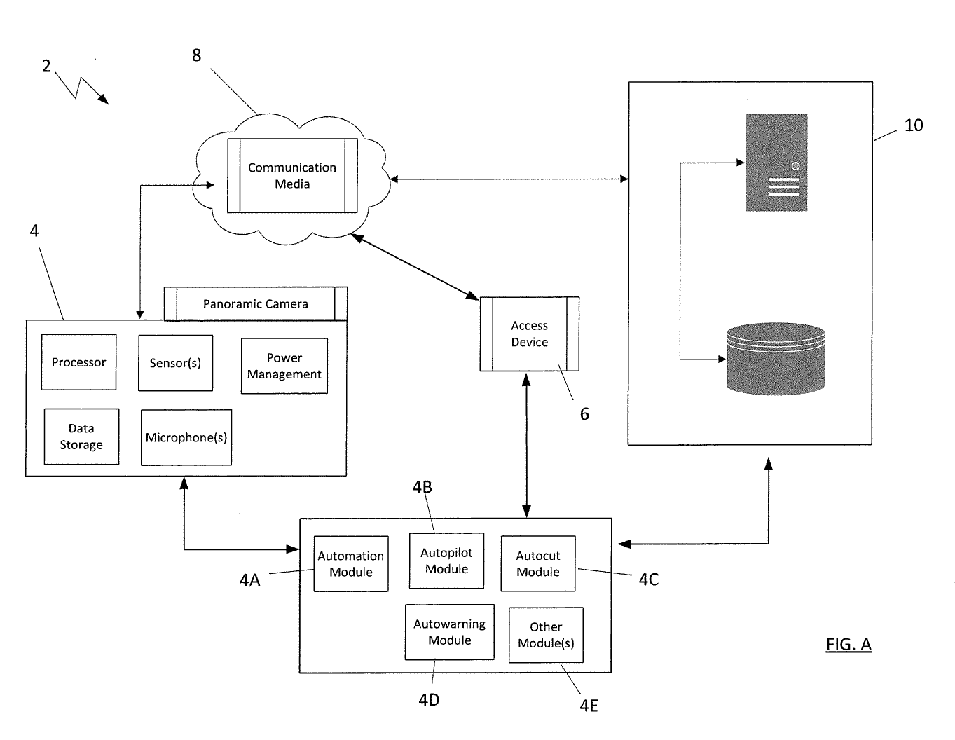

FIG. 1 shows an overview of one example of the operation and function of the automation module 4A. Video content captured by or derived from operation of the 360° camera 102 is communicated to and received by one or more virtual sensors 104, 106. The virtual sensors 104, 106 may be embodied as software or other like components capable of processing computer-implemented instructions for performing various tasks, such as the functions of the various modules 4A-4E described herein. The video content can be a recorded or stored video file or a live stream. The virtual sensors 104, 106 may be configured with a combination of computer vision and/or machine-learning algorithms to construct a feature space for each frame of the video content. Such algorithms may be embodied as machine learning algorithms understood by those skilled in the art and can cover the fields of “supervised learning,” “unsupervised learning,” or combinations involving “deep learning,” for example. This constructed feature space may then be used in an additional software component, an auto decider 108, to construct information to be used by a smart application 110 which may be executed to perform various tasks in connection with the modules 4A-4E described herein. The application 110 may have a feedback loop, for example, to set parameters of one or more of the virtual sensors 104, 106 or for reinforcement learning.

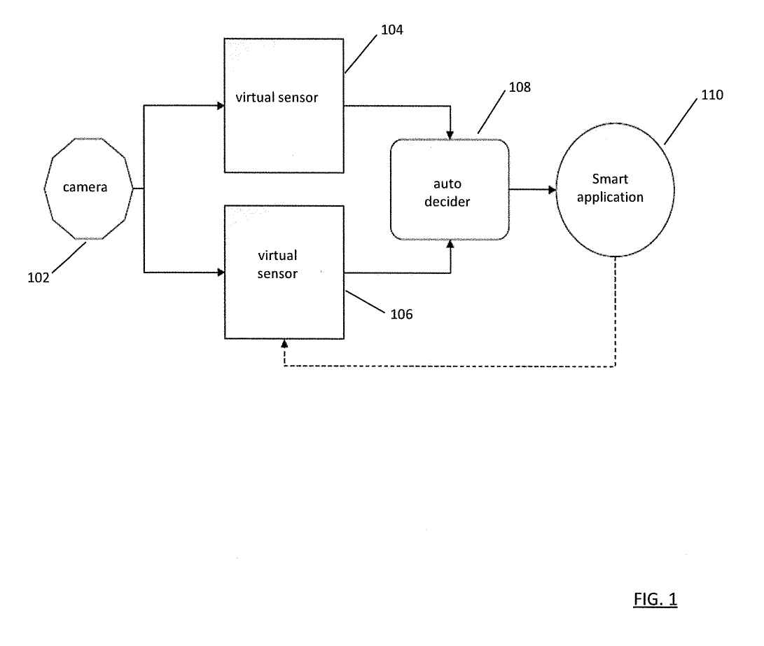

FIG. 2 illustrates an overview of the operation of the automation module 4A in association with the virtual sensors 104, 106. In one example, video content is sent from the 360° camera 102 to one or more virtual sensors 104, 106. In one embodiment, an interface 204 is provided to receive this video content and to perform operations frame by frame, for example. A filter layer 206 is used to reduce the information in the original video content. For example, filtering operations may include changing the color format to greyscale or black and white, changing the resolution of the video, selecting areas of interest, blurring, blobbing, and/or finding contours, among other filtering tasks. A data layer 208 takes this reduced information to compute features such as the differences between frames, edges and corners, movement vectors, or histogram values. Not all values associated with these features may be relevant for the functionality or tasks performed by the given smart application 110 (e.g., as implemented by the autopilot module 4B, the autocut module 4C, the autowarning module 4D, and/or other modules 4E). In many situations, computer vision algorithms can produce excessive noise in addition to the desired signal. Accordingly, a selection layer 210 can employ one or more machine learning algorithms to find the relevant content. The process shown in FIG. 2 results in data stored in a data table 212 that includes the relevant information for each frame of the video content.

The auto decider 108 can be programmed to combine the most relevant information derived from the sensors 104, 106. Based on this information, the auto decider 108 decides what data is sent to the smart application 110. In various embodiments, another semantic layer can be added because the data derived from the video data may not be representative of an adequate user viewing experience. Examples of tools employed by the semantic layer include smoothing processes or calculations over sequences of frames (e.g., Bayesian networks or hidden Markov models).

In various embodiments, the autopilot module 4B may be programmed to find the most interesting views in panoramic video content and guide the user through the video like a virtual camera operator. At least two tasks can be solved for a smart application performing functions in accordance with the autopilot module 4B: detecting the most interesting view or other content of interest, and translating information into a panning movement that simulates the actions of a real camera operator. The core element for these tasks is a virtual sensor 104, 106 that can detect movement in the video content while accounting for or ignoring the movement of the camera 102 itself.

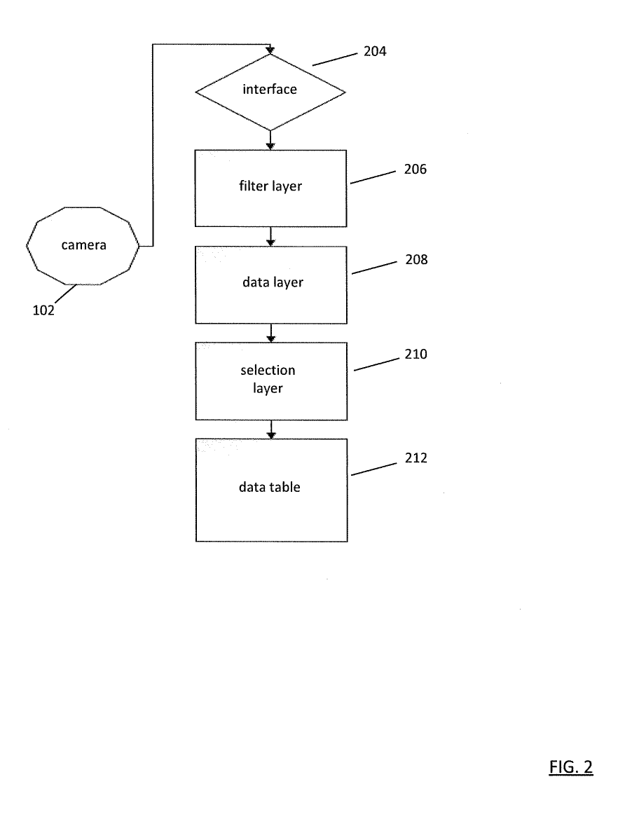

FIG. 3 describes the filter layer 206 of the sensors 104, 106 for movement detection as employed in connection with the autopilot module 4B. At step 304, the size in pixel of the video is scaled or reduced. The resulting image is then transferred to greyscale and an adaptive threshold is applied at step 306 to combine similar pixels in areas. Finally, the resulting picture is transferred to a data matrix containing only the grey-color values for each pixel at step 308. The results of two consecutive frames of video content are then transferred to the data layer 208.

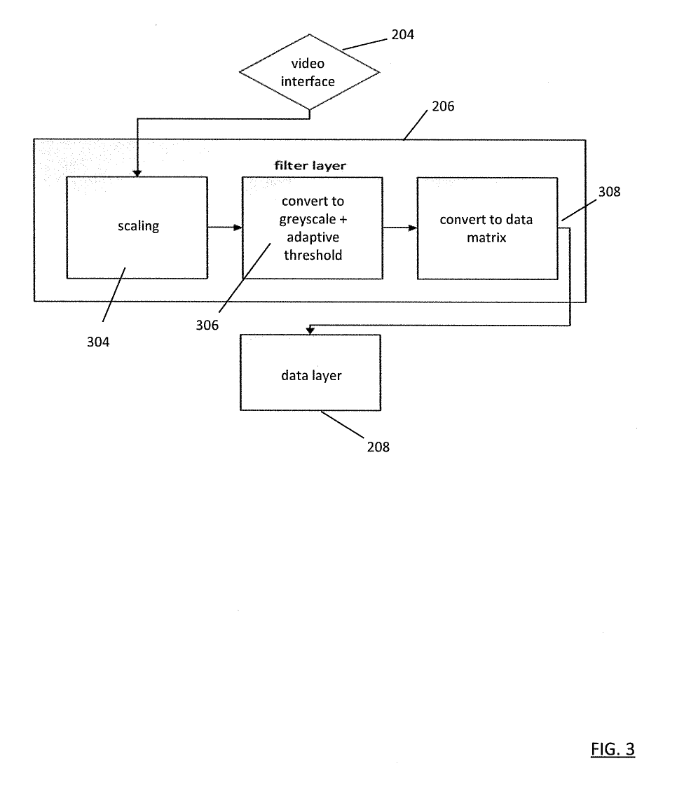

FIG. 4 shows examples of the processes performed within the data layer 208. The two data matrices are combined in a difference matrix at step 404. In a next step 406, blurring is used to reduce the number of the areas that are detected as movement. Finally, blobbing is used at step 408 to increase the size of the remaining areas. This process can be repeated until the number and size of remaining areas reach a defined threshold. The result is then transferred to the selection layer 210.

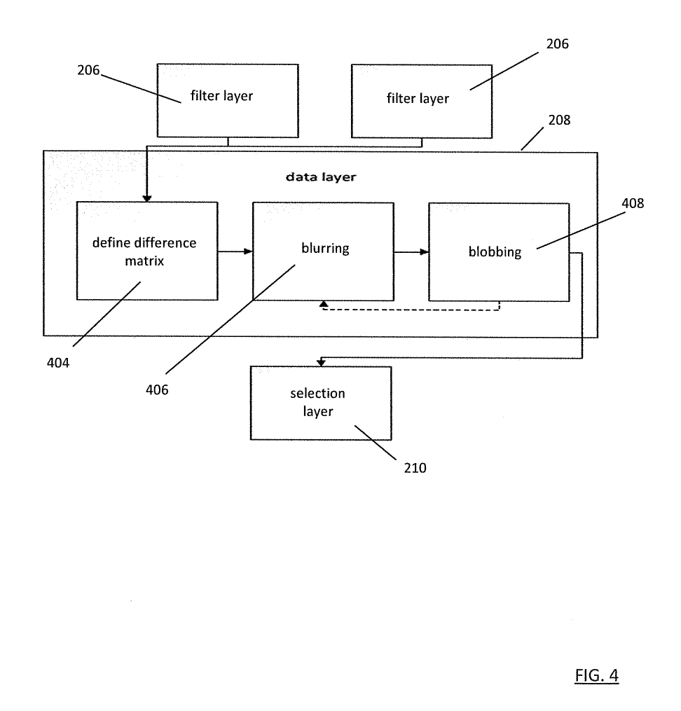

Panoramic video content is based on a polar representation of the three-dimensional space, which can lead to distortion of the actual size of objects. For example, objects closer to the camera appear to be much bigger while objects further away from the camera appear to be reduced significantly in size. The autopilot module 4B uses these characteristics of 360° videos to select the relevant areas of movements within the video content. In the selection layer 210, and with reference to FIG. 5, thresholds may be defined to remove comparatively smaller areas (at step 504) and comparatively bigger areas (at step 506) from the results of the data layer 208 processing. For the remaining areas, centroids can be calculated at step 508 and the sensors 104, 106 can be programmed to return a set of coordinates defining the center of the biggest remaining moving areas for each frame of the video content. The auto decider 108 uses the data from the virtual sensor 104, 106 and additional parameters set by the user in the autopilot module 4B to calculate the actual position of the desired view.

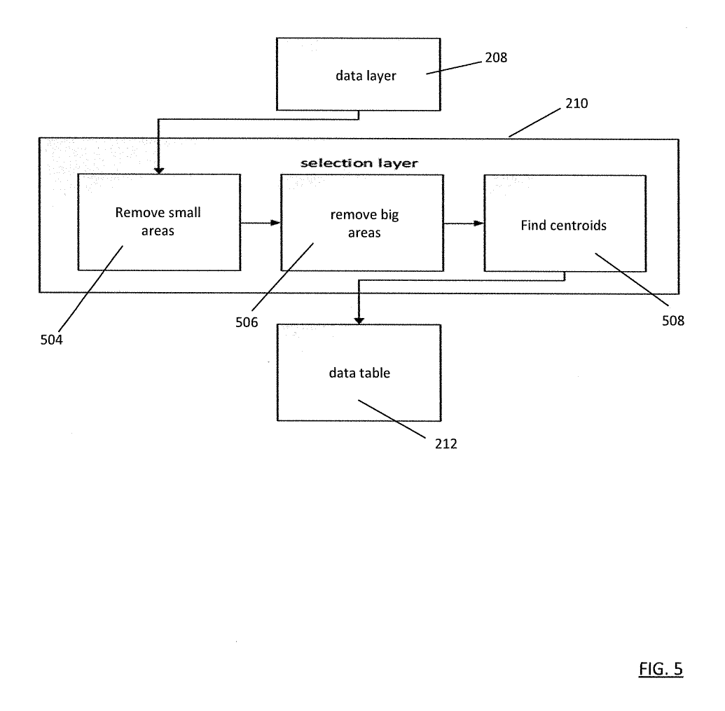

In various embodiments, and with reference to FIG. 6, the user can set a trigger 608 that starts and stops execution of the autopilot module 4B. In addition, the user can define the sensitivity 610 of the autopilot module 4B. Higher sensitivity leads to more and faster movements of the camera 102. Therefore, the autopilot module 4B can be adapted to the character of the video (e.g., passive video vs. action video) and the user's preferences. The auto decider 108 calculates the distance between the actual position of view in the spherical 360° video content and the position of the most moving area as defined by the virtual sensors 104, 106. In accordance with the desired sensitivity, the auto decider 108 moves the actual view in the direction of the center of interest or other content of interest. Due to the polar character of the 360° video content, these movements can be calculated as curves or smoothed coordinates at step 612 to simulate a natural movement. It can be appreciated that the functionality of adjusting the field of view of the video content performed by the autopilot module 4B can be configured to be activated or deactivated as desired by a user, for example. For example, activation or deactivation of the autopilot module 4B could be initiated through a command received from the access device 6 to activate or deactivate this functionality.

Because 360° cameras record the whole environment and not any particular angle, it is common practice to record longer periods of time and then decide later which scene is interesting. This decision is not easy for the user, because of the spherical character of the video. The user could either watch the video multiple times to see all different views that have been recorded, or the user could watch the video in its spherical representation. The first solution can be undesirably time-consuming; and the second solution usually leads to an inadequate user experience because the user is confronted with the distorted polar representation. In response to these problems, the autocut module 4C can be programmed to employ the described approach of the automation module 4A to automatically edit longer video footage to shorter video clips, for example, containing the most interesting scenes.

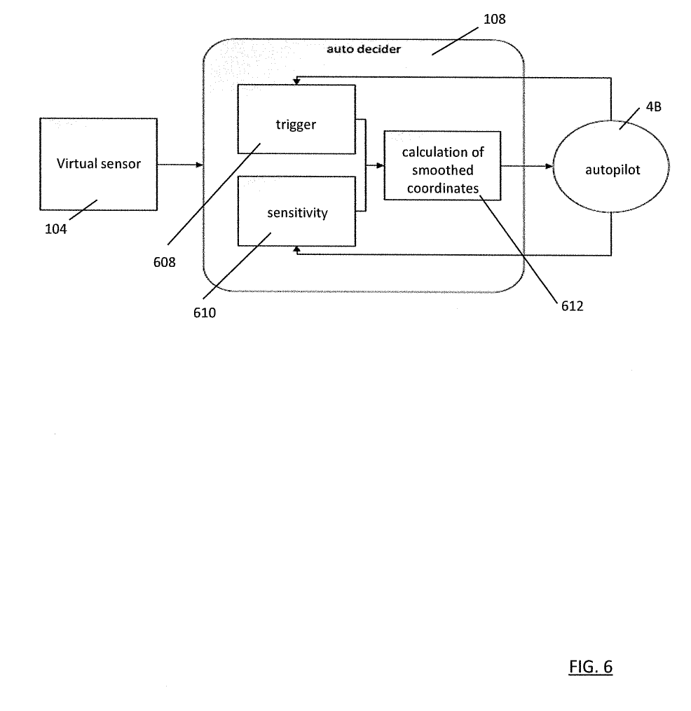

FIG. 7 shows the filter layer 206 applied in connection with the autocut module 4C. For each frame of the video, the color channels are separated at step 706. For each color channel, the histogram values are calculated at step 708. This means instead of reporting the position and the color of each pixel, the algorithm counts how many pixels are of which value and generates a histogram accordingly. This information is transferred to or converted to a data matrix at step 710 with, for example, 256 columns per color channel and rows for each frame of video content.

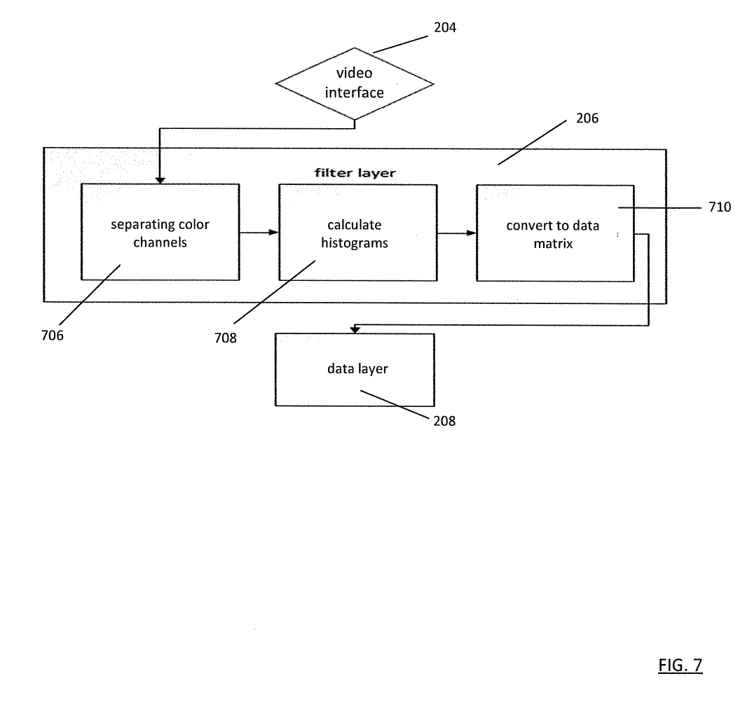

In the data layer 208 (see FIG. 8) the matrix from the filter layer 206 is first scaled at step 802 to have equal mean and standard deviation and then reduced in a principal component analysis at step 804. The result is a set of new values for each frame representing the variation across the original data but dramatically reduced. Finally, the data is divided in blocks of rows at step 806—e.g., blocks of 90 rows for cameras with 30 frames per seconds. For each block the standard deviation of the principal components is calculated. This value is higher for blocks in which the color of pixels is changing more frequently, for example.

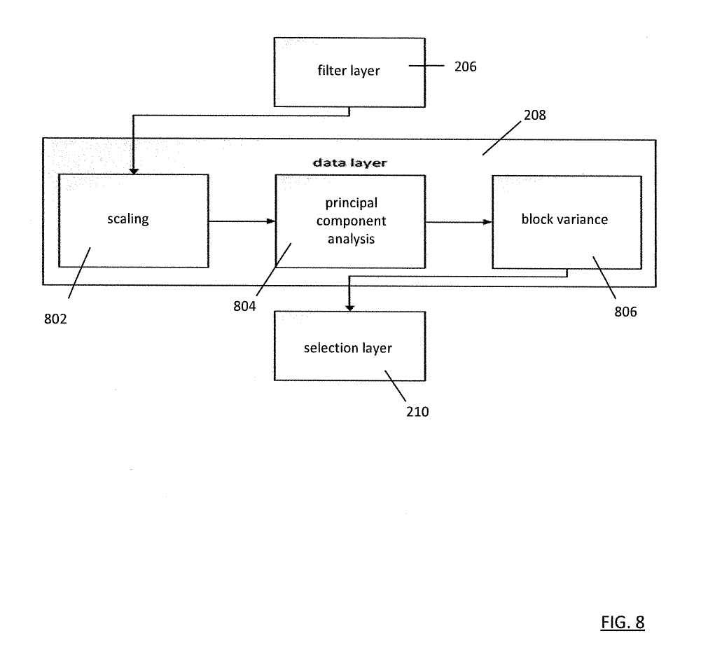

In the selection layer 210 (see FIG. 9) there are different pre-defined heuristics to combine the blocks to scenes of the desired length. An approach that fits many different types of video content is to use Fibonacci numbers at step 902 as a starting point for the heuristic framework. For example, one minute videos can be constructed by combining blocks of three seconds with the Fibonacci numbers 8, 5, 3, 2, and 1, resulting in defined scenes of 24 s, 15 s, 9 s, 6 s, and 3 s. A sequence that ends with two three-second scenes adds up to exactly one minute. The order of the scenes may be altered to create new heuristics. The user can decide how long the final video should be and the selection layer then combines the blocks in step 904 in accordance to the heuristic.

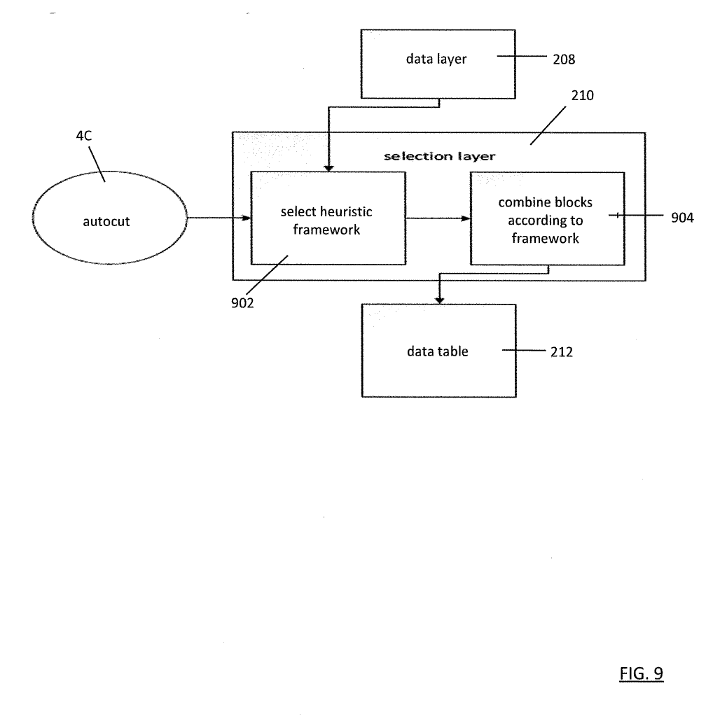

As can be seen in FIG. 10, the decision involving which scene or portion of the captured video content will be part of the shortened video can be made in two steps. First, areas of the original video are defined in relation to the length of the scenes from the heuristic framework at step 1002. For example, if the first scene in the heuristic frame work has duration of 24 s and the whole video should last 60 s the possible space for finding this scene in the original video equals 24 times the length of the original video divided by 60. The area defined by this relative cut is then inspected at step 1004 with an algorithm for numerical optimization. In one example, the task is to find the continuous scene in this area that has the highest sum of variance of blocks. This procedure ensures that the chronological order of the separate scenes stays valid.

A panoramic view offers the possibility to be aware of what goes on behind the user or otherwise in directions currently outside the user's line of sight or field of view. This can be extremely useful when the camera is mounted on a helmet or vehicle in a traffic situation, for example. The autowarning module 4D can be programmed to analyze the movements behind the user, or otherwise outside the field of view of the user, and issue a warning in case a vehicle or other obstacle is moving too quickly or too close to the vicinity of the user. The autowarning module 4D can employ the approach of the automation module 4A to solve this task. The autowarning module 4D can use real-time processing to solve the task, which is a different application of the same process as used in previous modules and applications described above.

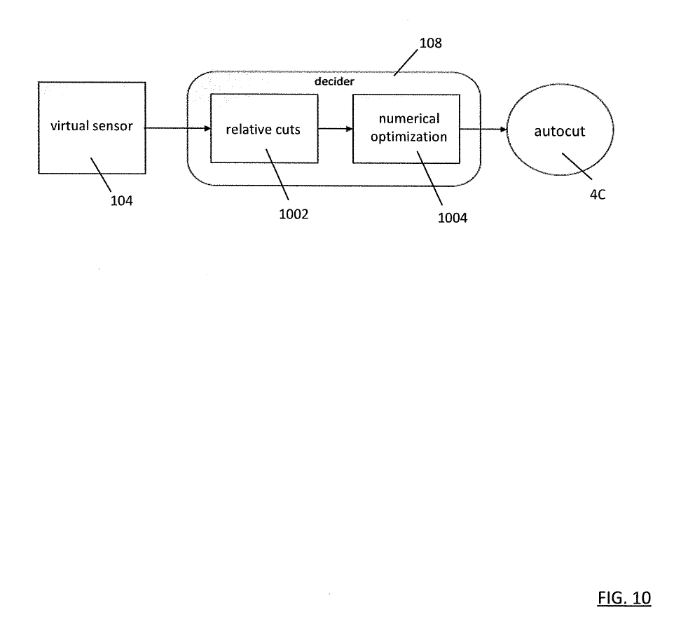

FIG. 11 shows the filter layer 206 as employed by the autowarning module 4D. The filter process during operation of the autowarning module 4D concentrates on a pre-defined region of interest at step 1102 which is behind or outside of the field of view of the user's forward motion. This reduction of the video content analysis can be used to optimize computational power for the real-time application. Next, at step 1104 the video can be converted to greyscale and the resolution adjusted to speed up further computations. Depending on the applied system, the order of these steps 1102, 1104 may be altered. At step 1106, in the remaining part of each video frame, corners and edges are automatically detected by computer vision algorithms known to those skilled in the art, such as optical flow methods.

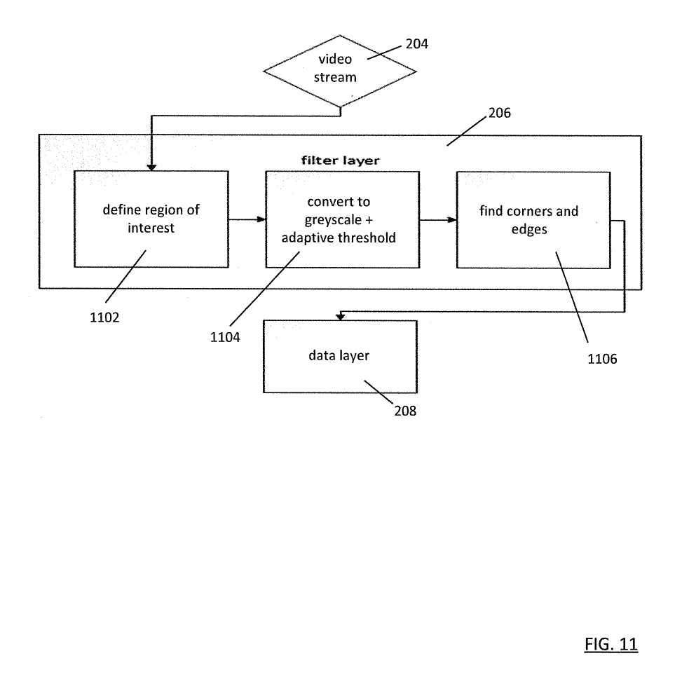

The results from the filter layer of two consecutive frames are then compared as shown in FIG. 12. At step 1202, the algorithm tries to match the corners and edges from both layers and calculates the optical flow, i.e., the movement of these corners and edges in relation to the movement of the camera itself, at step 1204. The results are combined at step 1206 in movement vectors of different magnitude, angle and coordinates.

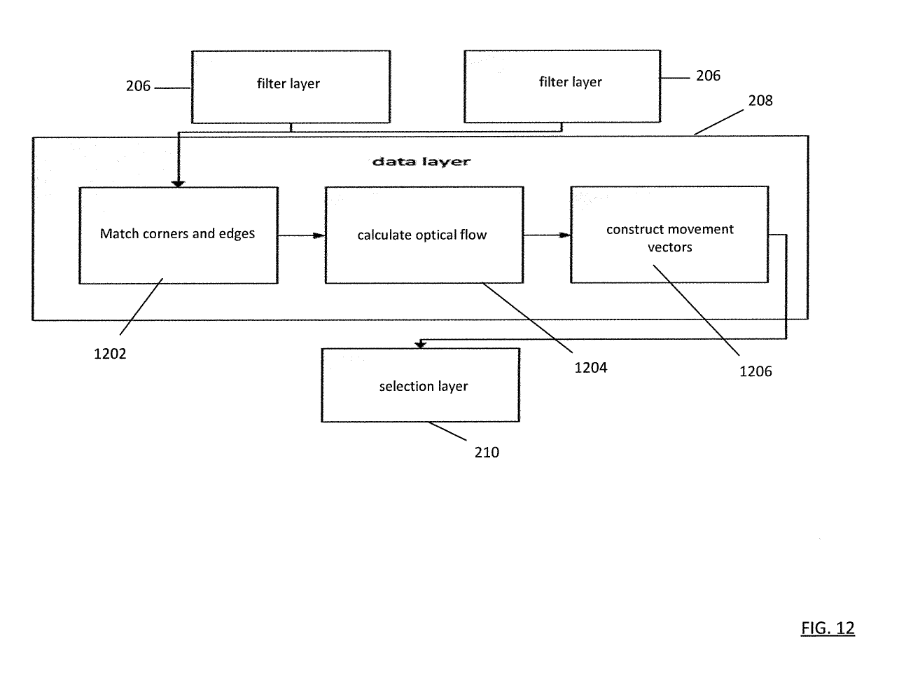

With reference to FIG. 13, appropriate selection of relevant movements is part of the operation of the autowarning module 4D. Because of the curvedness of the lens in 360° cameras, different corners of the same object will move in opposite directions in the spherical video when coming closer to the camera. The unique operation of embodiments of the autowarning module 4D includes the combination of corners and edges of moving objects via cluster analysis at step 1302. For each cluster, the movement vectors can be used to predict the position the object will have in the future at step 1304, if the direction and velocity of the camera 102 stays the same. Because the optical flow is always relative to the movement of the camera 102, the autowarning module 4D can predict which object is on a collision course with the camera 102. For example, consider a car that is very close but driving at a lower speed than the camera 102, then no collision will be predicted; while a car that is farther away but speeding in the same direction as the camera 102 could be evaluated as dangerous. Irrelevant clusters can be removed at step 1306 as part of the processing of the autowarning module 4D.

In one example, in a vehicle traffic situation with many fast moving objects and potentially changing lights and shadows the optical flow algorithm may produce false results. If the sensitivity is set too low, the algorithm might misclassify dangerous situations (false negatives). If the sensitivity is set too high, the system might issue many wrong warnings (false positives), which will lead to an erosion of trust. The optimum solution is to set the sensitivity for each video frame sufficiently high so that all situations that are possibly dangerous are classified as such.

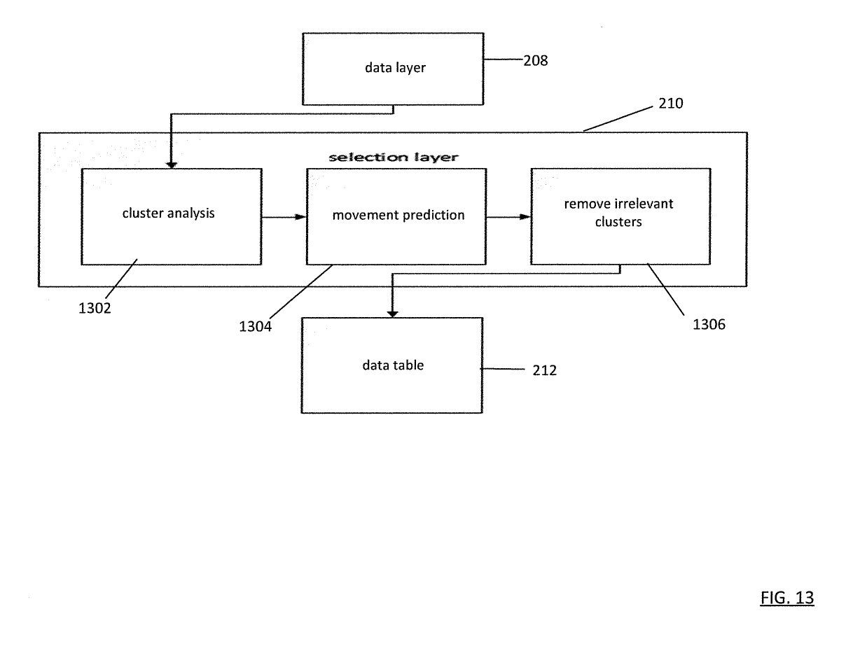

The decider 108 (see FIG. 14) now takes the probabilities reported by the virtual sensors 104, 106 and evaluates them in a Bayesian network 1402, for example. The probability of the first frame is taken as prior and is then combined with the next value. The result of this calculation is the prior for the next video frame, and so on. The result is an adaptive evaluation of how dangerous a situation compared against a critical threshold at step 1404. Because false positives are often caused by shadows or other random noise, their appearance is limited to single frames. The Bayesian network therefore delivers a robust result with acceptably few false positives and acceptably few false negatives.

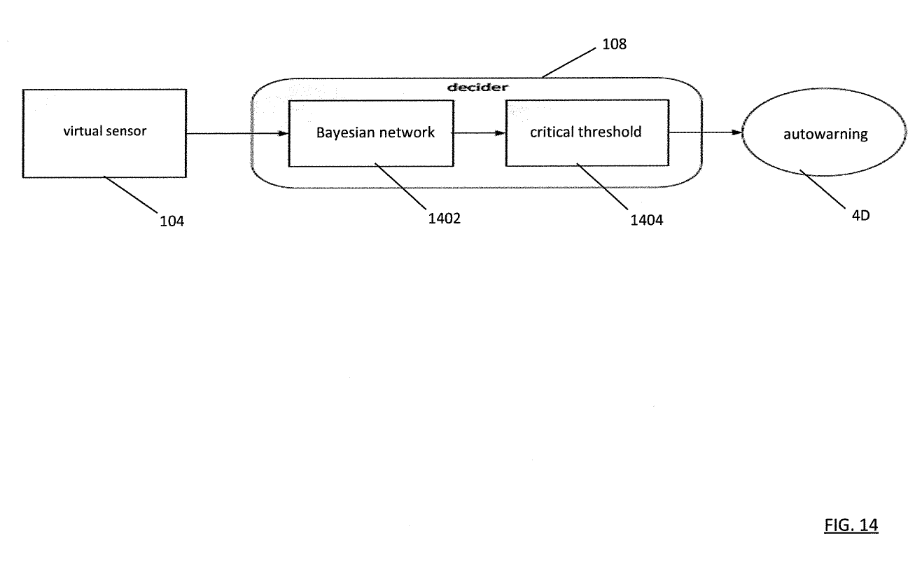

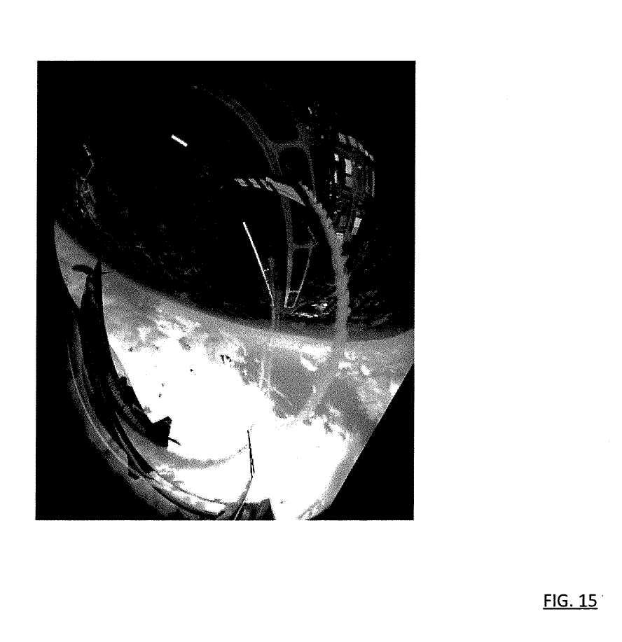

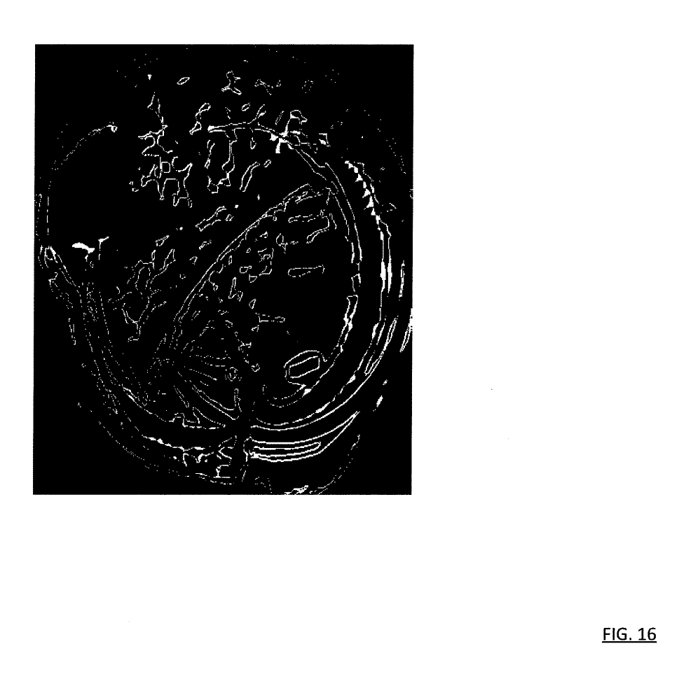

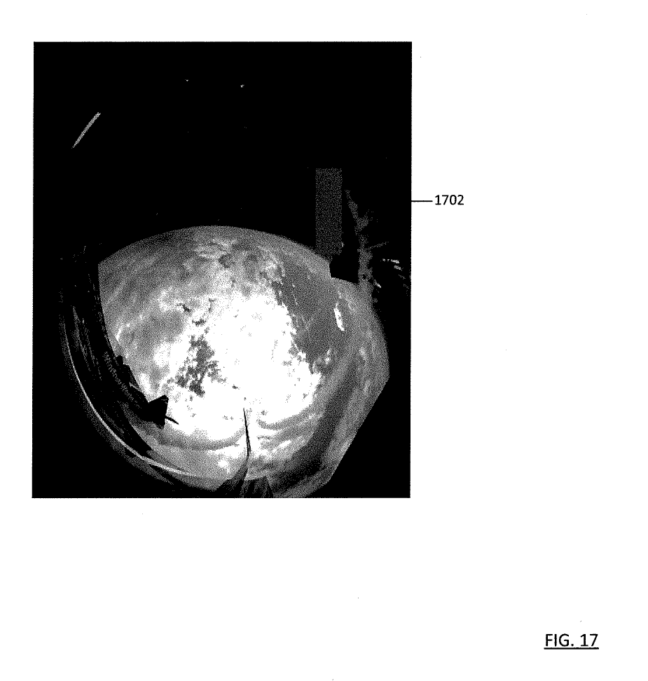

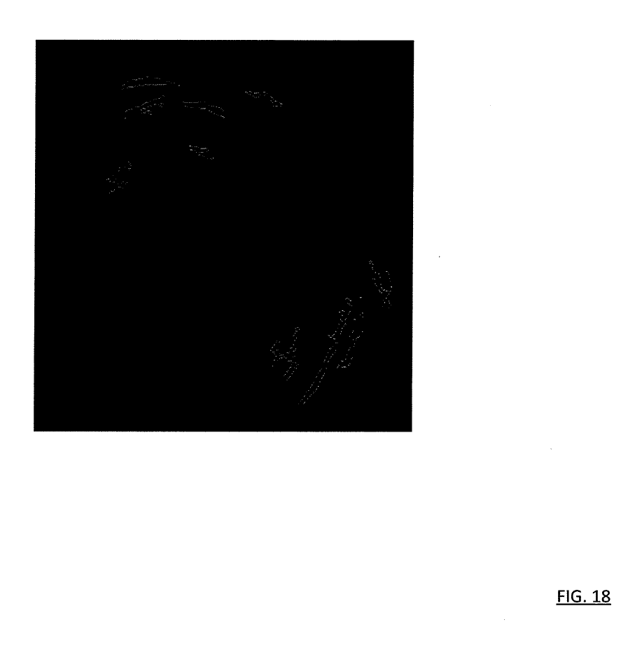

In connection with the operation of the modules 4B and 4C described above, FIG. 15 includes an example of originally captured panoramic video content. FIG. 16 includes an example of using machine learning techniques in connection with identifying patterns of movement in the panoramic video content of FIG. 15. FIG. 17 includes original panoramic video showing a pattern of interest (identified as represented by rectangular box 1702) which may have been identified in connection with a suitable pattern recognition technique applied to the content illustrated in FIG. 15. In another example, FIG. 18 includes an example of using machine learning techniques in connection with identifying patterns of movement in the panoramic video content of FIG. 15. FIG. 19 includes another example of identifying content of interest associated with the panoramic video content shown in FIG. 15 (identified as represented by rectangular box 1902).

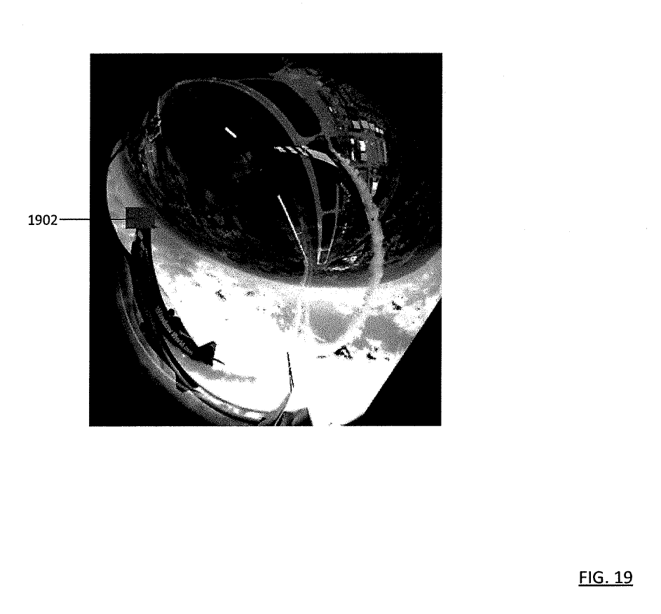

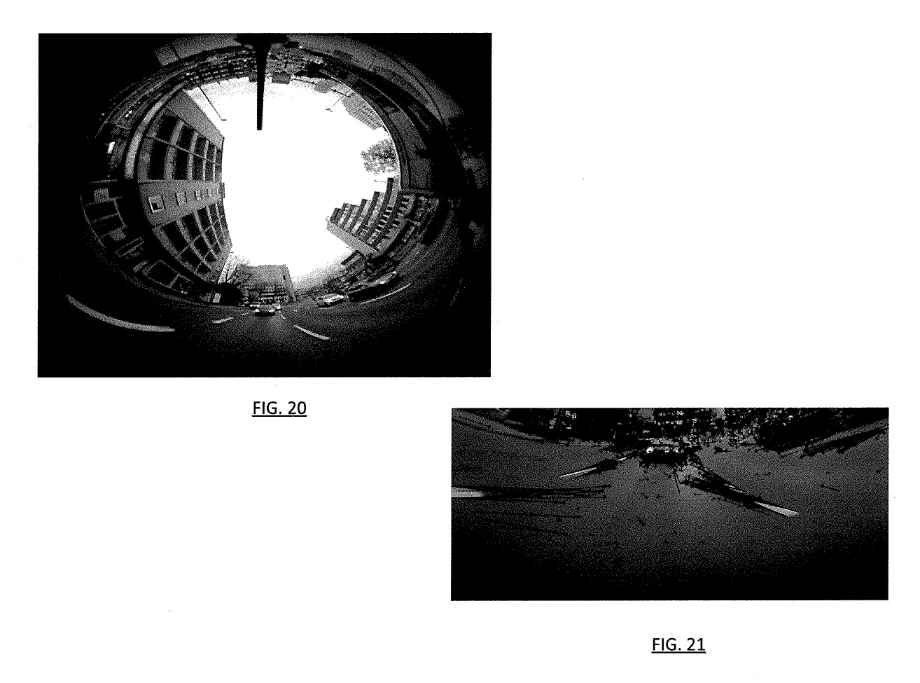

In connection with the autowarning module 4D described above, collision detection panoramic image data can be captured in the example shown in FIG. 20. Also, an example of application of machine learning techniques include application of a collision detection pattern recognition algorithm, for example, is shown in FIG. 21.

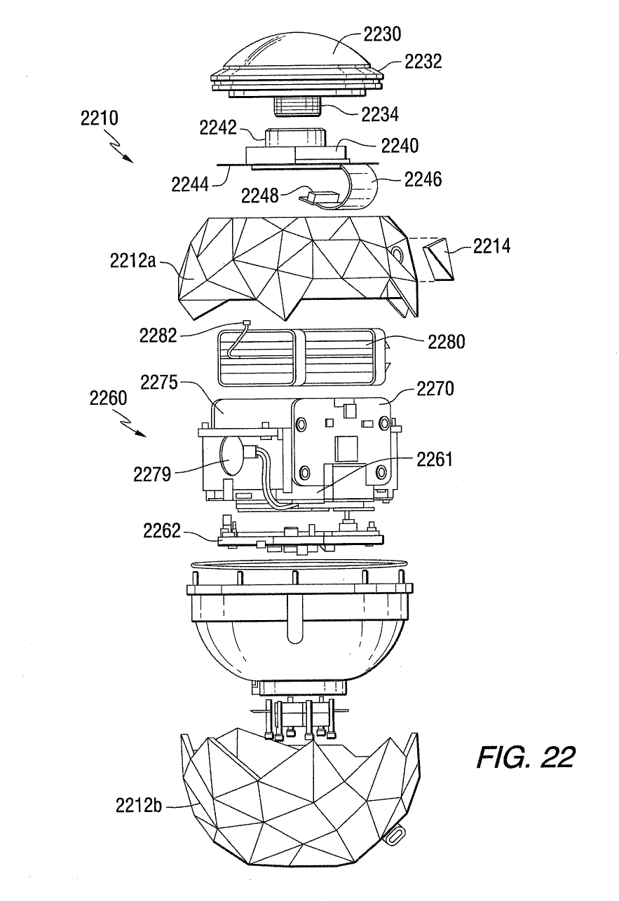

FIG. 22 is a side view of one example of a panoramic camera system 2210 which can be used in accordance with various embodiments of the invention. The panoramic lens 2230 and lens support ring 2232 are connected to a hollow mounting tube 2234 that is externally threaded. A video sensor 2240 is located below the panoramic lens 2230, and is connected thereto by means of a mounting ring 2242 having internal threads engageable with the external threads of the mounting tube 2234. The sensor 2240 is mounted on a sensor board 2244. A sensor ribbon cable 2246 is connected to the sensor board 2244 and has a sensor ribbon cable connector 2248 at the end thereof.

The sensor 2240 may comprise any suitable type of conventional sensor, such as CMOS or CCD imagers, or the like. For example, the sensor 2240 may be a high resolution sensor sold under the designation IMX117 by Sony Corporation. In certain embodiments, video data from certain regions of the sensor 2240 may be eliminated prior to transmission, e.g., the corners of a sensor having a square surface area may be eliminated because they do not include useful image data from the circular image produced by the panoramic lens assembly 2230, and/or image data from a side portion of a rectangular sensor may be eliminated in a region where the circular panoramic image is not present. In certain embodiments, the sensor 2240 may include an on-board or separate encoder. For example, the raw sensor data may be compressed prior to transmission, e.g., using conventional encoders such as jpeg, H.264, H.265, and the like. In certain embodiments, the sensor 2240 may support three stream outputs such as: recording H.264 encoded .mp4 (e.g., image size 1504×1504); RTSP stream (e.g., image size 750×750); and snapshot (e.g., image size 1504×1504). However, any other desired number of image streams, and any other desired image size for each image stream, may be used.

A tiling and de-tiling process may be used in accordance with the present invention. Tiling is a process of chopping up a circular image of the sensor 2240 produced from the panoramic lens 2230 into pre-defined chunks to optimize the image for encoding and decoding for display without loss of image quality, e.g., as a 1080p image on certain mobile platforms and common displays. The tiling process may provide a robust, repeatable method to make panoramic video universally compatible with display technology while maintaining high video image quality. Tiling may be used on any or all of the image streams, such as the three stream outputs described above. The tiling may be done after the raw video is presented, then the file may be encoded with an industry standard H.264 encoding or the like. The encoded streams can then be decoded by an industry standard decoder and the user side. The image may be decoded and then de-tiled before presentation to the user. The de-tiling can be optimized during the presentation process depending on the display that is being used as the output display. The tiling and de-tiling process may preserve high quality panoramic images and optimize resolution, while minimizing processing required on both the camera side and on the user side for lowest possible battery consumption and low latency. The image may be dewarped through the use of dewarping software or firmware after the de-tiling reassembles the image. The dewarped image may be manipulated by an app, as more fully described below.

As further shown in FIG. 22, the camera system 2210 includes a processor module 2260 comprising a support cage 2261. A processor board 2262 is attached to the support cage 2261. In addition, communication board(s) such as a WIFI board 2270 and Bluetooth board 2275 may be attached to the processor support cage 2261. Although separate processor, WIFI and Bluetooth boards 2262, 2270 and 2275 are shown in FIG. 22, it is understood that the functions of such boards may be combined onto a single board. Furthermore, additional functions may be added to such boards such as cellular communication and motion sensor functions, which are more fully described below. A vibration motor 2279 may also be attached to the support cage 2261.

The processor board 2262 may function as the command and control center of the camera system 2210 to control the video processing, data storage and wireless or other communication command and control. Video processing may comprise encoding video using industry standard H.264 profiles or the like to provide natural image flow with a standard file format. Decoding video for editing purposes may also be performed. Data storage may be accomplished by writing data files to an SD memory card or the like, and maintaining a library system. Data files may be read from the SD card for preview and transmission. Wireless command and control may be provided. For example, Bluetooth commands may include processing and directing actions of the camera received from a Bluetooth radio and sending responses to the Bluetooth radio for transmission to the camera. WIFI radio may also be used for transmitting and receiving data and video. Such Bluetooth and WIFI functions may be performed with the separate boards 2275 and 2270 illustrated in FIG. 22, or with a single board. Cellular communication may also be provided, e.g., with a separate board, or in combination with any of the boards described above.

A battery 2280 with a battery connector 2282 is provided. Any suitable type of battery or batteries may be used, such as conventional rechargeable lithium ion batteries and the like.

The camera system 2210 may include one or more motion sensors, e.g., as part of the processor module 2260. As used herein, the term “motion sensor” includes sensors that can detect motion, orientation, position and/or location, including linear motion and/or acceleration, rotational motion and/or acceleration, orientation of the camera system (e.g., pitch, yaw, tilt), geographic position, gravity vector, altitude, height, and the like. For example, the motion sensor(s) may include accelerometers, gyroscopes, global positioning system (GPS) sensors, barometers and/or compasses that produce data simultaneously with the optical and, optionally, audio data. Such motion sensors can be used to provide the motion, orientation, position and location information used to perform some of the image processing and display functions described herein. This data may be encoded and recorded. The captured motion sensor data may be synchronized with the panoramic visual images captured by the camera system 2210, and may be associated with a particular image view corresponding to a portion of the panoramic visual images, for example, as described in U.S. Pat. Nos. 8,730,322, 8,836,783 and 9,204,042.

Orientation based tilt can be derived from accelerometer data. This can be accomplished by computing the live gravity vector relative to the camera system 2210. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e. holding the device vertically may center the view on the horizon), or it may be used with an arbitrary offset for the convenience of the operator. This offset may be determined based on the initial orientation of the device when playback begins (e.g., the angular position of the device when playback is started can be centered on the horizon).

Any suitable accelerometer may be used, such as conventional 3-axis and 9-axis accelerometers. For example, a 3 axis BMA250 accelerometer from BOSCH or the like may be used. A 3-axis accelerometer may enhance the capability of the camera to determine its orientation in 3D space using an appropriate algorithm. The camera system 2210 may capture and embed the raw accelerometer data into the metadata path in a MPEG4 transport stream, providing the full capability of the information from the accelerometer that provides the user side with details to orient the image to the horizon.

The motion sensor may comprise a GPS sensor capable of receiving satellite transmissions, e.g., the system can retrieve position information from GPS data. Absolute yaw orientation can be retrieved from compass data, acceleration due to gravity may be determined through a 3-axis accelerometer when the computing device is at rest, and changes in pitch, roll and yaw can be determined from gyroscope data. Velocity can be determined from GPS coordinates and timestamps from the software platform's clock. Finer precision values can be achieved by incorporating the results of integrating acceleration data over time. The motion sensor data can be further combined using a fusion method that blends only the required elements of the motion sensor data into a single metadata stream or in future multiple metadata streams.

The motion sensor may comprise a gyroscope which measures changes in rotation along multiple axes over time, and can be integrated over time intervals, e.g., between the previous rendered frame and the current frame. For example, the total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset. Automatic roll correction can be computed as the angle between the device's vertical display axis and the gravity vector from the device's accelerometer.

Any suitable type of microphone may be provided inside the camera body 2212 near the microphone hole 2216 to detect sound. One or more microphones may be used inside and/or outside the camera body 2212. In addition to an internal microphone(s), at least one microphone may be mounted on the camera system 2210 and/or positioned remotely from the system. In the event that multiple channels of audio data are recorded from a plurality of microphones in a known orientation, the audio field may be rotated during playback to synchronize spatially with the interactive renderer display. The microphone output may be stored in an audio buffer and compressed before being recorded. In the event that multiple channels of audio data are recorded from a plurality of microphones in a known orientation, the audio field may be rotated during playback to synchronize spatially with the corresponding portion of the video image.

In accordance with embodiments of the present invention, the panoramic lens may comprise transmissive hyper-fisheye lenses with multiple transmissive elements (e.g., dioptric systems); reflective mirror systems (e.g., panoramic mirrors as disclosed in U.S. Pat. Nos. 6,856,472; 7,058,239; and 7,123,777, which are incorporated herein by reference); or catadioptric systems comprising combinations of transmissive lens(es) and mirror(s). In certain embodiments, the panoramic lens 2230 comprises various types of transmissive dioptric hyper-fisheye lenses. Such lenses may have fields of view FOVs as described above, and may be designed with suitable F-stop speeds. F-stop speeds may typically range from f/1 to f/8, for example, from f/1.2 to f/3. As a particular example, the F-stop speed may be about f/2.5.

The images from the camera system 2210 may be displayed in any suitable manner. For example, a touch screen may be provided to sense touch actions provided by a user. User touch actions and sensor data may be used to select a particular viewing direction, which is then rendered. The device can interactively render the texture mapped video data in combination with the user touch actions and/or the sensor data to produce video for display. The signal processing can be performed by a processor or processing circuitry.

Video images from the camera system 2210 may be downloaded to various display devices, such as a smart phone using an app, or any other current or future display device. Many current mobile computing devices, such as the iPhone, contain built-in touch screen or touch screen input sensors that can be used to receive user commands. In usage scenarios where a software platform does not contain a built-in touch or touch screen sensor, externally connected input devices can be used. User input such as touching, dragging, and pinching can be detected as touch actions by touch and touch screen sensors though the usage of off the shelf software frameworks.

User input, in the form of touch actions, can be provided to the software application by hardware abstraction frameworks on the software platform. These touch actions enable the software application to provide the user with an interactive presentation of prerecorded media, shared media downloaded or streamed from the internet, or media which is currently being recorded or previewed.

An interactive renderer may combine user input (touch actions), still or motion image data from the camera (via a texture map), and movement data (encoded from geospatial/orientation data) to provide a user controlled view of prerecorded media, shared media downloaded or streamed over a network, or media currently being recorded or previewed. User input can be used in real time to determine the view orientation and zoom. As used in this description, real time means that the display shows images at essentially the same time the images are being sensed by the device (or at a delay that is not obvious to a user) and/or the display shows images changes in response to user input at essentially the same time as the user input is received. By combining the panoramic camera with a mobile computing device, the internal signal processing bandwidth can be sufficient to achieve the real time display.

The user can select from live view from the camera, videos stored on the device, view content on the user (full resolution for locally stored video or reduced resolution video for web streaming), and interpret/re-interpret sensor data. Proxy streams may be used to preview a video from the camera system on the user side and are transferred at a reduced image quality to the user to enable the recording of edit points. The edit points may then be transferred and applied to the higher resolution video stored on the camera. The high-resolution edit is then available for transmission, which increases efficiency and may be an optimum method for manipulating the video files.

The camera system of the present invention may be used with various apps. For example, an app can search for any nearby camera system and prompt the user with any devices it locates. Once a camera system has been discovered, a name may be created for that camera. If desired, a password may be entered for the camera WIFI network also. The password may be used to connect a mobile device directly to the camera via WIFI when no WIFI network is available. The app may then prompt for a WIFI password. If the mobile device is connected to a WIFI network, that password may be entered to connect both devices to the same network.

The app may enable navigation to a “cameras” section, where the camera to be connected to WIFI in the list of devices may be tapped on to have the app discover it. The camera may be discovered once the app displays a Bluetooth icon for that device. Other icons for that device may also appear, e.g., LED status, battery level and an icon that controls the settings for the device. With the camera discovered, the name of the camera can be tapped to display the network settings for that camera. Once the network settings page for the camera is open, the name of the wireless network in the SSID field may be verified to be the network that the mobile device is connected on. An option under “security” may be set to match the network's settings and the network password may be entered. Note some WIFI networks will not require these steps. The “cameras” icon may be tapped to return to the list of available cameras. When a camera has connected to the WIFI network, a thumbnail preview for the camera may appear along with options for using a live viewfinder or viewing content stored on the camera.

In situations where no external WIFI network is available, the app may be used to navigate to the “cameras” section, where the camera to connect to may be provided in a list of devices. The camera's name may be tapped on to have the app discover it. The camera may be discovered once the app displays a Bluetooth icon for that device. Other icons for that device may also appear, e.g., LED status, battery level and an icon that controls the settings for the device. An icon may be tapped on to verify that WIFI is enabled on the camera. WIFI settings for the mobile device may be addressed in order to locate the camera in the list of available networks. That network may then be connected to. The user may then switch back to the app and tap “cameras” to return to the list of available cameras. When the camera and the app have connected, a thumbnail preview for the camera may appear along with options for using a live viewfinder or viewing content stored on the camera.

In certain embodiments, video can be captured without a mobile device. To start capturing video, the camera system may be turned on by pushing the power button. Video capture can be stopped by pressing the power button again.

In other embodiments, video may be captured with the use of a mobile device paired with the camera. The camera may be powered on, paired with the mobile device and ready to record. The “cameras” button may be tapped, followed by tapping “viewfinder.” This will bring up a live view from the camera. A record button on the screen may be tapped to start recording. To stop video capture, the record button on the screen may be tapped to stop recording.

To playback and interact with a chosen video, a play icon may be tapped. The user may drag a finger around on the screen to change the viewing angle of the shot. The video may continue to playback while the perspective of the video changes. Tapping or scrubbing on the video timeline may be used to skip around throughout the video.

Firmware may be used to support real-time video and audio output, e.g., via USB, allowing the camera to act as a live web-cam when connected to a PC. Recorded content may be stored using standard DCIM folder configurations. A YouTube mode may be provided using a dedicated firmware setting that allows for “YouTube Ready” video capture including metadata overlay for direct upload to YouTube. Accelerometer activated recording may be used. A camera setting may allow for automatic launch of recording sessions when the camera senses motion and/or sound. A built-in accelerometer, altimeter, barometer and GPS sensors may provide the camera with the ability to produce companion data files in .csv format. Time-lapse, photo and burst modes may be provided. The camera may also support connectivity to remote Bluetooth microphones for enhanced audio recording capabilities.

The panoramic camera system 2210 of the present invention has many uses. The camera may be mounted on any support structure, such as a person or object (either stationary or mobile). For example, the camera may be worn by a user to record the user's activities in a panoramic format, e.g., sporting activities and the like. Examples of some other possible applications and uses of the system in accordance with embodiments of the present invention include: motion tracking; social networking; 360° mapping and touring; security and surveillance; and military applications.

For motion tracking, the processing software can be written to detect and track the motion of subjects of interest (people, vehicles, etc.) and display views following these subjects of interest.

For social networking and entertainment or sporting events, the processing software may provide multiple viewing perspectives of a single live event from multiple devices. Using geo-positioning data, software can display media from other devices within close proximity at either the current or a previous time. Individual devices can be used for n-way sharing of personal media (much like YouTube or flickr). Some examples of events include concerts and sporting events where users of multiple devices can upload their respective video data (for example, images taken from the user's location in a venue), and the various users can select desired viewing positions for viewing images in the video data. Software can also be provided for using the apparatus for teleconferencing in a one-way (presentation style—one or two-way audio communication and one-way video transmission), two-way (conference room to conference room), or n-way configuration (multiple conference rooms or conferencing environments).

For 360° mapping and touring, the processing software can be written to perform 360° mapping of streets, buildings, and scenes using geospatial data and multiple perspectives supplied over time by one or more devices and users. The apparatus can be mounted on ground or air vehicles as well, or used in conjunction with autonomous/semi-autonomous drones. Resulting video media can be replayed as captured to provide virtual tours along street routes, building interiors, or flying tours. Resulting video media can also be replayed as individual frames, based on user requested locations, to provide arbitrary 360° tours (frame merging and interpolation techniques can be applied to ease the transition between frames in different videos, or to remove temporary fixtures, vehicles, and persons from the displayed frames).

For security and surveillance, the apparatus can be mounted in portable and stationary installations, serving as low profile security cameras, traffic cameras, or police vehicle cameras. One or more devices can also be used at crime scenes to gather forensic evidence in 360° fields of view. The optic can be paired with a ruggedized recording device to serve as part of a video black box in a variety of vehicles; mounted either internally, externally, or both to simultaneously provide video data for some predetermined length of time leading up to an incident.

For military applications, man-portable and vehicle mounted systems can be used for muzzle flash detection, to rapidly determine the location of hostile forces. Multiple devices can be used within a single area of operation to provide multiple perspectives of multiple targets or locations of interest. When mounted as a man-portable system, the apparatus can be used to provide its user with better situational awareness of his or her immediate surroundings. When mounted as a fixed installation, the apparatus can be used for remote surveillance, with the majority of the apparatus concealed or camouflaged. The apparatus can be constructed to accommodate cameras in non-visible light spectrums, such as infrared for 360° heat detection.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, device configurations, or process flows described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that a sufficient understanding of the present invention can be gained by the present disclosure, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers. Software or other sets of instructions that may be employed to cause programmable equipment to execute the processes may be stored in any storage device, such as a computer system (non-volatile) memory. Furthermore, some of the processes may be programmed when the computer system is manufactured or via a computer-readable memory storage medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. Memory and/or storage components may be implemented using any computer-readable media capable of storing data such as volatile or non-volatile memory, removable or non-removable memory, erasable or non-erasable memory, writeable or re-writeable memory, and forth. Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

A “computer,” “computer system,” “computing apparatus,” “component,” or “computer processor” may be, for example and without limitation, a processor, microcomputer, minicomputer, server, mainframe, laptop, personal data assistant (PDA), wireless e-mail device, smart phone, mobile phone, electronic tablet, cellular phone, pager, fax machine, scanner, or any other programmable device or computer apparatus configured to transmit, process, and/or receive data. Computer systems and computer-based devices disclosed herein may include memory and/or storage components for storing certain software applications used in obtaining, processing, and communicating information. It can be appreciated that such memory may be internal or external with respect to operation of the disclosed embodiments. In various embodiments, a “host,” “engine,” “loader,” “filter,” “platform,” or “component” may include various computers or computer systems, or may include a reasonable combination of software, firmware, and/or hardware. In certain embodiments, a “module” may include software, firmware, hardware, or any reasonable combination thereof.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described hereinabove may be implemented in computer software using any suitable computer programming language such as .NET or HTML using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Pert Various embodiments may be employed in a Lotus Notes environment, for example. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the access device to the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but which also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

As employed herein, an application server may be a server that hosts an API to expose business logic and business processes for use by other applications. Examples of application servers include J2EE or Java EE 5 application servers including WebSphere Application Server. Other examples include WebSphere Application Server Community Edition (IBM), Sybase Enterprise Application Server (Sybase Inc), WebLogic Server (BEA), JBoss (Red Hat), JRun (Adobe Systems), Apache Geronimo (Apache Software Foundation), Oracle OC4J (Oracle Corporation), Sun Java System Application Server (Sun Microsystems), and SAP Netweaver AS (ABAP/Java). Also, application servers may be provided in accordance with the .NET framework, including the Windows Communication Foundation, .NET Remoting, ADO.NET, and ASP.NET among several other components. For example, a Java Server Page (JSP) is a servlet that executes in a web container which is functionally equivalent to CGI scripts. JSPs can be used to create HTML pages by embedding references to the server logic within the page. The application servers may mainly serve web-based applications, while other servers can perform as session initiation protocol servers, for instance, or work with telephony networks. Specifications for enterprise application integration and service-oriented architecture can be designed to connect many different computer network elements. Such specifications include Business Application Programming Interface, Web Services Interoperability, and Java EE Connector Architecture.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

Certain embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein.

Although various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and, consequently, are not described in detail herein.

The flow charts and methods described herein show the functionality and operation of various implementations. If embodied in software, each block, step, or action may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flow charts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment. The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as claimed herein.

1. A method executable by a processor for processing 360° video content captured by a panoramic video camera, the method comprising:
applying at least one machine learning algorithm to at least a portion of the 360° video content to determine at least one pattern within the 360° video content;
comparing at least two video frames of the 360° video content to determine whether the at least one pattern has changed within the 360° video content;
determining content of interest relating to a change in the at least one pattern when the at least one pattern has changed within the 360° video content; and
automatically panning to and displaying, within a field of view of the 360° video content, at least a portion of the content of interest.

2. The method of claim 1, wherein a change in the at least one pattern indicates movement of an object within the 360° video content.

3. The method of claim 1, wherein the at least a portion of the 360° video content is derived from stored video content.

4. The method of claim 1, wherein the at least a portion of the 360° video content is derived from live video content.

5-7. (canceled)

8. The method of claim 1, further comprising:
receiving, from a user, an input defining an amount of change required in the at least one pattern in order for the processor to determine that the at least one pattern has changed within the 360° video content.

9. The method of claim 8, wherein automatically panning to and displaying at least a portion of the content of interest comprises:
moving within the field of view of the 360° video content to at least a portion of the content of interest in accordance with the user input and in response to at least one set of smoothed coordinates.

10. The method of claim 1, further comprising:
selecting one or more portions of the 360° video content based on the content of interest to produce selected video content; and
compiling a video including the selected video content, wherein the compiled video is shorter in time length than the 360° video content.

11. The method of claim 10, further comprising:
applying a filter layer for separating multiple color channels of the selected video content with at least one histogram value.

12. The method of claim 10, wherein selecting one or more portions of the 360° video content based on the content of interest comprises:
applying a heuristic framework for selecting the one or more portions of the 360° video content.

13-18. (canceled)

19. A panoramic video camera system comprising:
a panoramic lens facilitating capture of 360° video content;
a video sensor positioned below the panoramic lens to capture 360° video content through the panoramic lens; and
a processor programmed for:
applying at least one machine learning algorithm to at least a portion of the 360° video content to determine at least one pattern within the 360° video content;
comparing at least two video frames of the 360° video content to determine whether the at least one pattern has changed within the 360° video content;
determining content of interest relating to a change in the at least one pattern when the at least one pattern has changed within the 360° video content; and
automatically pan to and display, within a field of view of the 360° video content, at least a portion of the content of interest.

20. A non-transitory computer-readable medium including instructions which when executed by a processor cause the processor to:
apply at least one machine learning algorithm to at least a portion of 360° video content captured by a panoramic video camera to determine at least one pattern within the 360° video content;
compare at least two video frames of the 360° video content to determine whether the at least one pattern has changed within the 360° video content;
determine content of interest relating to a change in the at least one pattern when the at least one pattern has changed within the 360° video content; and
automatically pan to and display, within a field of view of the 360° video content, at least a portion of the content of interest.

21. The method of claim 1, wherein comparing at least two video frames of the 360° video content to determine whether the at least one pattern has changed comprises:
calculating a difference between the two video frames;
creating a background model to subtract movement of the panoramic video camera;
shrinking and blurring moving areas of the 360° video content to combine connected pixels;
measuring a remaining amount of moving areas that were not shrunk or blurred; and
filtering the remaining amount of moving areas according to a curvedness of a lens of the panoramic video camera.

22. The method of claim 21, wherein determining content of interest relating to a change in the at least one pattern comprises:
reporting for each video frame of the at least two video frames coordinates of a largest remaining pixel area.
